(19) United States
(12) Patent Application Publication
(10) Pub. No.: US 2026/0103605 A1
(43) Pub. Date: Apr. 16, 2026

(54) ANTI-GLARE FILM

(71) Applicant: BenQ Materials Corporation, Taoyuan (TW)

(72) Inventors: YU-JIE SHEN, Taoyuan (TW); CHING-HUANG CHEN, Taoyuan (TW); KUO-HSUAN YU, Taoyuan (TW)

(73) Assignee: BenQ Materials Corporation, Taoyuan (TW)

(21) Appl. No.: 18/973,876

(22) Filed: Dec. 9, 2024

(30) Foreign Application Priority Data
Oct. 11, 2024 (TW) 113138638

(51) Int. Cl. C09D 5/00; C09D 7/40; C09D 7/61; C09D 7/63; C09D 133/08

(52) U.S. Cl. CPC C09D 5/006; C09D 7/61; C09D 7/63; C09D 7/68; C09D 7/69; C09D 133/08

(57) ABSTRACT

An anti-glare film is disclosed, which comprises a recycled polyethylene terephthalate substrate and an anti-glare coating layer on the recycled PET (rPET) substrate. The recycled PET substrate contains at least 50% recycled PET resin, and the anti-glare coating layer includes an acrylate binder resin and a plurality of amorphous inorganic microparticles. The disclosed anti-glare film has a concave-convex surface formed on the surface of the anti-glare coating layer by the amorphous inorganic microparticles to effectively mask impurity particles and/or microbubbles in the recycled PET substrate for being used in display devices.

### CROSS-REFERENCE TO RELATED APPLICATION

This application claims the priority benefit of Taiwanese Application Ser. No. TW113138638, filed on Oct. 11, 2024, which is incorporated herein by reference.

### BACKGROUND OF THE INVENTION

### Field of Invention

This invention relates to an anti-glare film for displays, and particularly relates to an anti-glare film with a recycled polyethylene terephthalate (rPET) substrate.

### Description of Related Art

Polyethylene terephthalate (PET) is a versatile plastic that is widely used in various applications, including packaging, textiles and films. With the demand for environmental sustainability and the advancement of recycling technology, rPET (recycled PET) can reduce the reliance on virgin PET and minimize waste, contributes to sustainable development and supports the circular economy.

In recent years, PET recycling is a well-established process. However, due to the complex sources of rPET, the rPET contains various complex fragment particles that cannot be melted during the shredding and melting processes, such as residual dyes, adhesives, or other contaminants. These impurities and contaminants can lead to inclusions or microbubbles in rPET, which may cause defects in its performance. Currently, rPET is widely used in industries such as packaging, textiles, automotive components, and construction. However, there are still challenges and drawbacks that need to be solved in optical-related industries.

Viewing the importance of rPET in protecting the environment, saving resources, reducing energy consumption and promoting a sustainable circular economy, the present invention provides an optical grade anti-glare film made of rPET substrate that can be used in displays to expand the application area of rPET.

### SUMMARY OF THE INVENTION

The present invention is to provide a recycled polyethylene terephthalate (rPET) to be used as a substrate to prepare an anti-glare film, wherein the anti-glare coating layer on the rPET substrate can effectively mask the impurity particles or microbubbles in the rPET substrate for use in displays.

The anti-glare film provided in the present invention comprises a rPET substrate and an anti-glare coating layer coated on the rPET substrate, wherein the rPET substrate comprises at least 50% recycled PET resin, the anti-glare coating layer comprises an acrylate binder resin and a plurality of amorphous inorganic microparticles, for example but not limited to amorphous silica microparticles, the use amount of the amorphous inorganic microparticles is ranging from 0.5 weight parts to 20.0 weight parts per hundred weight parts of acrylate binder resin.

In the disclosed anti-glare film, the rPET substrate has a haze of 0.1% to 3% and a light transmittance of at least 88% and a thickness of 40 μm to 80 μm.

The total haze of the disclosed anti-glare film is more than 15% and the surface haze thereof is more than 12%.

In the disclosed anti-glare film, the average particle size of the amorphous inorganic microparticles is ranging from 2.0 μm to 10 μm, BET specific surface area thereof is ranging from 60 m²/g to 300 m²/g and the particle size distribution is ranging from 0.2 μm to 25.0 μm measured by laser diffraction.

In the disclosed anti-glare film, the amorphous inorganic microparticles form a concave-convex surface with a plurality of irregular protrusions on the anti-glare layer, the surface roughness of the concave-convex surface has an maximum height (Sz) ranging from 5.0 μm to 20.0 μm, an arithmetical mean height (Sa) ranging from 0.10 μm to 1.0 μm, a root mean square gradient (SΔq) ranging from 0.10° to 1.5° and a developed interfacial area ratio (Sdr) ranging from 1.0% to 45.0%.

In the disclosed anti-glare film, the thickness of the anti-glare coating layer is ranging from 2 μm to 10 μm, and preferably is ranging from 3 μm to 8 μm.

In the disclosed anti-glare film, the rPET substrate comprises at least 80% recycled PET resin.

In the disclosed anti-glare film, the use amount of the amorphous inorganic microparticles is ranging from 1.0 weight parts to 18.0 weight parts per hundred weight parts of acrylate binder resin.

In the disclosed anti-glare film, the anti-glare coating layer can further comprise a plurality of spherical organic microparticles, the average particle size of the spherical organic microparticles is ranging from 1.0 μm to 5.0 μm. In the anti-glare coating layer of the present anti-glare film, the use amount of the spherical organic microparticles is ranging from 1.0 weight parts to 15.0 weight parts per hundred weight parts of acrylate binder resin.

In the disclosed anti-glare film, the amorphous inorganic microparticles are amorphous silica microparticles.

The above and other aspects of the invention will become better understood with regard to the following detailed description of the preferred but non-limiting embodiment(s). These and other aspects of the invention will become apparent from the following description of the presently preferred embodiments. The detailed description is merely illustrative of the invention and does not limit the scope of the invention, which is defined by the appended claims and equivalents thereof. As would be obvious to one skilled in the art, many variations and modifications of the invention may be affected without departing from the spirit and scope of the novel concepts of the disclosure.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details.

It is apparent that departures from specific designs and methods described and shown will suggest themselves to those skilled in the art and may be used without departing from the spirit and scope of the invention. The present invention is not restricted to the particular constructions described and illustrated, but should be construed to cohere with all modifications that may fall within the scope of the appended claims.

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art.

Hereinafter, the parameters of surface roughness are defined as below. The maximum height (Sz) refers to the sum of the maximum peak height (Sp) and maximum valley depth (Sv) within a defined area; the arithmetical mean height (Sa) refers to the arithmetic mean of absolute coordinates Z (x, y) within a defined area; the root mean square gradient (SΔq) refers to the mean magnitude of the partial gradient (slope) of the surface; and the developed interfacial area ratio (Sdr) refers to the rate of an increase in the surface area which is calculated from the surface area derived by the projected area.

Moreover, the term “(meth)acrylate” used herein refers to acrylate or methacrylate.

The present invention is to provide an anti-glare film comprising a rPET substrate an anti-glare coating layer coated on the rPET substrate, wherein the rPET substrate comprises at least 50% recycled PET resin, the anti-glare coating layer comprise an acrylate binder resin and a plurality of amorphous inorganic microparticles, for example but not limited to amorphous silica microparticles, The present anti-glare film comprises a concave-convex surface formed by the amorphous inorganic microparticles on the anti-glare coating layer to effectively mask the impurity particles and/or microbubbles in the rPET substrate for use in displays.

The rPET substrate used in the present anti-glare film comprises at least 50% recycled PET resin and has haze ranging of 0.1% to 3% (determined according to the description of JIS K7136) and light transmittance of at least 88% (determined according to the description of JIS K7361), and the thickness ranging of 40 μm to 80 μm. The rPET substrate used in the present anti-glare film can be commercial product, such as RESHINE™ rPET film commercially obtained from Toyobo Co., Ltd, Japan.

In the related state of the functional optical film technology, the substrate for the functional optical film is preferably a transparent substrate with a light transmittance of more than 90% and a haze of 0% to meet the optical requirements. The present anti-glare film comprises a substrate which is rPET film containing at least 50% recycled PET resin with a haze ranging of 0.1% to 3.0% (determined according to the description of JIS K7136) and light transmittance of at least 88% (determined according to the description of JIS K7361), and an anti-glare coating layer formed by an acrylate binder resin containing amorphous inorganic microparticles, for example but not limited to amorphous silica microparticles. The present anti-glare film has a total haze more than 15% and a surface haze more than 12%. The anti-glare coating layer of the present anti-glare film can effectively mask the impurity particles and/or microbubbles in the rPET substrate for use in displays.

In the anti-glare film of a preferred embodiment of the present invention, the rPET substrate comprises at least 80% recycled PET resin.

The anti-glare coating layer of the present anti-glare film comprises acrylate binder resin and a plurality of amorphous inorganic microparticles, for example but not limited to amorphous silica microparticles, the use amount of the amorphous inorganic microparticles is ranging from 0.5 weight parts to 20.0 weight parts per hundred weight parts of acrylate binder resin, and is preferably ranging from 1.0 weight parts to 18.0 weight parts.

In the disclosed anti-glare film, the average particle size of the amorphous inorganic microparticles of the anti-glare coating layer is ranging from 2.0 μm to 10.0 μm, and preferably is ranging from 2.0 μm to 8.0 μm, and the BET specific surface area thereof is ranging from 60 m²/g to 300 m²/g. Moreover, the amorphous inorganic microparticles used in the present invention are the microparticles with a wide particle size distribution, for example, the particle size distribution ranging from 0.2 μm to 25.0 μm, and preferably is ranging from 0.3 μm to 20.0 μm measured by laser diffraction. The amorphous inorganic microparticles can be amorphous silica microparticles, such as Nipsil® SS-50B commercially obtained from Tosoh Silica Co., but not limited thereto. In another embodiment of the present invention, those with ordinary knowledge in the related art can select other amorphous inorganic microparticles as required.

In the disclosed anti-glare film, the amorphous inorganic microparticles form a concave-convex surface with a plurality of irregular protrusions on the anti-glare layer, the surface roughness of the concave-convex surface has an maximum height (Sz) ranging from 5.0 μm to 20.0 μm, an arithmetical mean height (Sa) ranging from 0.10 μm to 1.0 μm, a root mean square gradient (SΔq) ranging from 0.10° to 1.5° and a developed interfacial area ratio (Sdr) ranging from 1.0% to 45.0%.

The anti-glare film of a preferred embodiment of the present invention, the concave-convex surface of the anti-glare coating layer formed by the amorphous inorganic microparticles has an maximum height (Sz) ranging from 7.0 μm to 18.0 μm, an arithmetical mean height (Sa) ranging from 0.20 μm to 0.80 μm, a root mean square gradient (SΔq) ranging from 0.15° to 1.2° and a developed interfacial area ratio (Sdr) ranging from 1.5% to 42.0%.

In the disclosed anti-glare film, the thickness of the anti-glare coating layer on the rPET substrate is ranging from 2.0 μm to 10.0 μm, and preferably is ranging from 3.0 μm to 8.0 μm.

In the disclosed anti-glare film, the acrylate binder resin used in the anti-glare coating layer comprises a (meth)acrylate compositions and an initiator, wherein the (meth)acrylate composition comprises the polyurethane (meth)acrylate oligomer of 35 to 50 weight percent with a functionality of 6 to 15, the (meth)acrylate monomer of 12 to 20 weight percent at least one with a functionality of 3 to 6 and the (meth)acrylate monomer of 1.5 to 12 weight percent at least one with a functionality less than 3.

In a preferred embodiment of the present invention, the polyurethane (meth)acrylate oligomer with a functionality of 6 to 15 is preferably a polyurethane (meth)acrylate oligomer with a molecular weight ranging of 1,500 and 4,500.

In a preferred embodiment of the present invention, the (meth)acrylate monomer with a functionality of 3 to 6 is a (meth)acrylate monomer with molecular weight less than 800. The suitable (meth)acrylate monomer with a functionality of 3 to 6 can be at least one of pentaerythritol triacrylate (PETA), dipentaerythritol hexaacrylate (DPHA) or dipentaerythritol pentaacrylate (DPPA) or the combination thereof, but not limited thereto.

In a preferred embodiment of the present invention, the (meth)acrylate monomer with a functionality less than 3 can be the (meth)acrylate monomer with a functionality of 1 or 2, and the molecular weight thereof is less than 500. The (meth)acrylate monomer with a functionality less than 3 can be at least one of 1,6-hexanediol diacrylate (HDDA), cyclic trimethylolpropane formal acrylate (CTFA), 2-phenoxyethyl acrylate (PHEA) or isobornyl acrylate (IBOA) or the combination thereof, but not limited thereto.

The suitable initiator used in the acrylic binder resin of the present invention can be selected from those commonly used in the related art, such as, for example, but not limited to, acetophenones-based initiator, diphenylketones-based initiator, propiophenones-based initiator, benzophenones-based initiator, bifunctional α-hydroxyketones-based initiator, acylphosphine oxides-based initiator and the like. The above-mentioned initiators can be used alone or in combination.

The anti-glare layer of the present anti-glare film can be added with a leveling agent to provide a good leveling and smoothness of the coated surface. The leveling agent used herein can optionally be a leveling agent with a recoatability, therefore the other optical function layers can be coated on the high-haze anti-glare film. The fluorine-based, (meth)acrylate-based or organosilicon-based leveling agents can be used in the anti-glare coating layer of the disclosed anti-glare film.

In the disclosed anti-glare film, the anti-glare coating layer can further comprise a plurality of spherical organic microparticles to adjust the haze of the anti-glare film. The spherical organic microparticles can be the spherical organic microparticles with average particle size of 1.0 μm to 5.0 μm. In the present anti-glare film, the use amount of the spherical organic microparticles is ranging from 1.0 weight parts to 15.0 weight parts per hundred weight parts of the acrylate binder resin, and preferably ranging from 2.0 weight parts to 10.0 weight parts.

The spherical organic microparticles suitably used in the disclosed anti-glare coating layer can be polymethyl methacrylate resin microparticles, polystyrene resin microparticles, styrene-methyl methacrylate copolymer microparticles, melamine microparticles, polyethylene resin microparticles, epoxy resin microparticles, and silicone resin microparticles, polyvinylidene fluoride resin or polyvinyl fluoride resin microparticles.

Another aspect of the present invention is to provide a method for preparing an anti-glare film. The method for preparing an anti-glare film comprising the steps of mixing a (meth)acrylate composition comprises a polyurethane (meth)acrylate oligomer with a functionality of 6 to 15, at least one (meth)acrylate monomer with a functionality of 3 to 6, at least one (meth)acrylate monomer with functionality of less than 3, an initiator and adequate solvent(s) and stirred evenly for preparing an acrylate binder resin solution; adding a plurality of amorphous inorganic microparticles, a leveling agent and adequate solvent(s) into the acrylate binder resin solution and stirring evenly for preparing an anti-glare solution; and coating the anti-glare solution on a rPET substrate, drying the rPET substrate coated with the anti-glare solution and curing by radiation or electron beam for forming an anti-glare coating on the rPET substrate to obtain an anti-glare film.

The solvents suitable for preparation of the present anti-glare film can be the organic solvents commonly used in the related art, such as ketones, aliphatic, cycloaliphatic or aromatic hydrocarbons, ethers, esters or alcohols.

In other embodiments of the present invention, other additives such as antistatic agents, colorants, flame retardants, ultraviolet absorbers, antioxidants, surface modifiers, antimicrobial agents, silica nanoparticles with hydrophobic modification or defoaming agents can be added to the anti-glare solution as required.

The above-mentioned anti-glare coating solution can be applied to the rPET substrate surface by any method known in the related art, for example, bar coating, doctor blade coating, dip coating, roll coating, spinning coating, slot-die coating and the like.

The present anti-glare film can further comprise a low reflective layer coated on the anti-glare coating layer to provide anti-reflection and increased light-transmittance for enhancing the darkroom contrast ratio but maintaining the anti-glare property.

The present invention will be explained in further detail with reference to the examples. However, the present invention is not limited to these examples.

### Example

### Preparation Example 1: Preparation of the Acrylate Binder Resin

42 weight parts of polyurethane acrylate oligomer (functionality 6, molecular weight of about 1,600, viscosity of 36,000 cps (at 25° C.), commercially obtained from IGM Resins, Netherlands), 4.5 weight parts of PETA, 12 weight parts of DPHA, 3 weight parts of CTFA, 4 weight parts of photoinitiator (Chemcure-481, commercially obtained from Chembridge, Taiwan), 24.5 weight parts of ethyl acetate (EAC) and 10 weight parts of n-butyl acetate (nBAC) were mixed and stirred for 1 hour to prepare the acrylate binder resin.

### Example 1: Preparation of an Anti-Glare Film

100 weight parts of acrylate binder resin obtained from the Preparation Example 1, 1.5 weight parts of amorphous silica microparticles (Nipsil® SS-50B, average particle size 4.0 μm, BET specific surface area of 80 m²/g, a particle size distribution from 0.7 μm to 15.0 μm determined by a laser diffraction, commercially obtained from Tosoh Silica Co., Japan), 0.28 weight parts of wetting and dispersing agent (DisperBYK-2150, solid content 5%, solvent: propylene glycol methyl ether acetate/n-butyl acetate, commercially obtained from BYK, Germany), 20 weight parts of polyether-modified polydimethylsiloxane leveling agent (BYK-UV3535, solid content 10%, solvent: n-butyl acetate, commercially obtained from BYK, Germany), 4.5 weight parts of silica nanoparticle dispersant (NanoBYK-3650, average particle size 20 nm, solid content 31%, solvent: propylene glycol monomethyl ether acetate/propylene glycol monomethyl ether, commercially obtained from BYK, Germany), 16.6 weight parts of ethyl acetate (EAC) and 70 weight parts of n-butyl acetate (nBAC) were mixed and stirred for 1 hour to evenly disperse to prepare an anti-glare coating solution.

The resulting anti-glare coating solution was then coated on a 50 μm rPET substrate with a haze of 1.9% and light transmittance of 89% (RESHINE™, Toyobo Co., Ltd, Japan). After the coating layer was dried, the layer was cured by exposure to UV light in a cumulative dosage of 298 mJ/cm² under nitrogen atmosphere. An anti-glare film with a 4.0 μm anti-glare coating layer on the rPET substrate was obtained.

The properties of the obtained anti-glare film were determined in accordance with the optical and physical properties measurement described hereinafter, and the test results were shown in Table 1.

Thickness measurement: The thickness of the anti-glare film was determined according to the test method of JIS K5600-1-7:2014 by Inductive Digital Comparator Extramess 2001 (Mahr Inc., Germany).

Light transmittance measurement: The light transmittance was measured according to the test method of JIS K7361 by NDH-2000 Haze Meter (manufactured by Nippon Denshoku Industries, Japan).

Haze measurement: The haze was measured according to the test method of JIS K7136 by NDH-2000 Haze Meter (manufactured by Nippon Denshoku Industries, Japan).

Inner haze and surface haze measurement: A prepared sample was obtained by adhering a TAC substrate (T40UZ, thickness 40 μm, available from Fujifilm, Japan) with a transparent optical adhesive on the anti-glare films to flatten the uneven surface of the anti-glare film. In this state, the haze of prepared sample was measured according to the test method of JIS K7136 by NDH-2000 Haze Meter was the inner haze, and the surface haze could be obtained from the total haze deducted the inner haze.

Gloss measurement: The gloss of the anti-glare films was obtained by adhering the anti-glare films to a black acrylic plate and measuring the gloss thereof according to the test method of JIS Z8741 by BYK Micro-Gloss gloss meter at viewing angles of 20, 60 and 85 degrees.

Clarity measurement: The obtained anti-glare film was cut into a sample with an area of 5×8 cm². Measuring the anti-glare film according to the test method of JIS K7374 by SUGA ICM-IT image clarity meter, and the sum of the measured values at slits of 0.125 mm, 0.25 mm, 0.50 mm, 1.00 mm and 2.00 mm was the clarity.

Anti-glare evaluation: A prepared sample was obtained by adhering the anti-glare films to a black acrylic plate, and the surfaces of the prepared samples were illuminated by 2 fluorescent tubes to check the status of reflected by observation. The evaluation criteria were as below.
Lv.1: Two separate fluorescent tubes could be seen clearly and the straight outlines of tubes was distinguished obviously;
Lv.2: Two separate fluorescent tubes could be seen clearly, but the outlines of tubes were slightly fuzzy;
Lv.3: Two separate fluorescent tubes could be seen, and although the outlines of tubes were fuzzy but the shapes of tubes could be distinguished;
Lv.4: It could be seen that there were 2 fluorescent tubes, but the shapes of tubes could not be distinguished;
Lv.5: It could not be seen that there were 2 fluorescent tubes and the shapes of tubes could not be distinguished.

Roughness measurement: A prepared sample was obtained by adhering the anti-glare film to a black acrylic plate with transparent optical adhesive, and the prepared sample was photographed four 3D surface roughness images with an area of 640×640 μm² by OLYMPUS LEXT OLS5000-SAF 3D laser conjugate focus microscope arranging a MPLAPON20×LEXT objective lens. The arithmetical mean height (Sa), the maximum height (Sz), the root mean square gradient (SΔq) and the developed interfacial area ratio (Sdr) of the anti-glare film could be measured according to the description of surface roughness of ISO 25178-2:2012, and each item was tested for 5 times and the average was taken.

Impurity masking evaluation on display: The anti-glare films were prepared by a rPET substrate with marked location of impurities. The antiglare film was adhered by an optical clear adhesive to a SHARP AQOUS 8K LC-70X500T LCD display, the anti-glare film of which was removed. The visibility of the impurities on the display was evaluation at viewing angle of 0 to 60 degrees. If the invisibility rate was 100%, the evaluation was “excellent” (⊚); if the invisibility rate was more than 75% but lower than 100%, the evaluation was “good” (◯), if the invisibility rate was more than 50% but lower than 75%, the evaluation was “fair” (Δ), if the invisibility rate was lower than 50%, the evaluation was “poor” (X). The invisibility rate was calculated by the number of invisible impurities at the marked locations divided by the number of marked locations. The result was shown in Table 1.

### Example 2: Preparation of an Anti-Glare Film

The anti-glare film of Example 2 was prepared in the same manner as in Example 1, except that 3 weight parts of the amorphous silica microparticles and 0.55 weight parts of wetting and dispersing agent were used to prepare an anti-glare coating solution. The anti-glare coating solution was then coated on a 50 μm rPET substrate with a haze of 1.9% and light transmittance of 89% (RESHINE™, Toyobo Co., Ltd, Japan). After being dried and cured as in Example 1, an anti-glare film with a 4.2 μm anti-glare coating layer on the rPET substrate was obtained and the optical and physical properties thereof were determined. The results were showed in Table 1.

### Example 3: Preparation of an Anti-Glare Film

The anti-glare film of Example 3 was prepared in the same manner as in Example 1, except that 6 weight parts of the amorphous silica microparticles and 1.1 weight parts of wetting and dispersing agent were used to prepare anti-glare coating solution. The anti-glare coating solution was then coated on a 50 μm rPET substrate with a haze of 1.9% and light transmittance of 89% (RESHINE™, Toyobo Co., Ltd, Japan). After being dried and cured as in Example 1, an anti-glare film with 4.2 μm anti-glare coating layer on the rPET substrate was obtained and the optical and physical properties thereof were determined. The results were showed in Table 1.

### Example 4: Preparation of an Anti-Glare Film

The anti-glare film of Example 4 was prepared in the same manner as in Example 1, except that 7.0 weight parts of amorphous silica microparticles and 1.9 weight parts of wetting and dispersing agent were used and 3.1 weight parts of spherical polystyrene microparticles (XX-40IK, average particle size 3 μm, available from Sekisui Plastics Co. Ltd., Japan) was added to prepare an anti-glare coating solution. The anti-glare coating solution was then coated on a 50 μm rPET substrate with a haze of 1.9% and light transmittance of 89% (RESHINE™, Toyobo Co., Ltd, Japan). After being dried and cured as in Example 1, an anti-glare film with a 5.8 μm anti-glare coating layer on the rPET substrate was obtained and the optical and physical properties thereof were determined. The results were showed in Table 1.

### Example 5: Preparation of an Anti-Glare Film

The anti-glare film of Example 5 was prepared in the same manner as in Example 1, except that 10.6 weight parts of amorphous silica microparticles and 2.9 weight parts wetting and dispersing agent were used and 3.3 weight parts of spherical polystyrene (XX-40IK, average particle size 3 μm, available from Sekisui Plastics Co. Ltd., Japan) was added to prepare an anti-glare coating solution. The anti-glare coating solution was then coated on a 50 μm rPET substrate with a haze of 1.9% and light transmittance of 89% (RESHINE™, Toyobo Co., Ltd, Japan). After being dried and cured as in Example 1, an anti-glare film with a 5.8 μm anti-glare coating layer on the rPET substrate was obtained and the optical and physical properties thereof were determined. The results were showed in Table 1.

### Example 6: Preparation of an Anti-Glare Film

The anti-glare film of Example 6 was prepared in the same manner as in Example 1, except that 3.9 weight parts of amorphous silica microparticles and 1.1 weight parts of wetting and dispersing agent were used and 6.6 weight parts of spherical polyistyrene (XX-40IK, average particle size 3 μm, available from Sekisui Plastics Co. Ltd., Japan) was added to prepare an anti-glare coating solution. The anti-glare coating solution was then coated on a 50 μm rPET substrate with a haze of 1.9% and light transmittance of 89% (RESHINE™, Toyobo Co., Ltd, Japan). After being dried and cured as in Example 1, an anti-glare film with a 5.0 μm anti-glare coating layer on the rPET substrate was obtained and the optical and physical properties thereof were determined. The results were showed in Table 1.

TABLE 1
The physical properties of anti-glare
film obtained from Examples 1-6

| Example | | | 1 | 2 | 3 | 4 | 5 | 6 |
|---|---|---|---|---|---|---|---|---|
| Light transmittance (%) | | | 88.95 | 88.02 | 89.39 | 88.61 | 90.29 | 90.01 |
| Total haze (%) | | | 15.01 | 29.29 | 54.86 | 45.11 | 73.76 | 46.12 |
| Surface haze (%) | | | 12.48 | 26.85 | 51.04 | 25.99 | 52.77 | 15.24 |
| Inner haze (%) | | | 2.53 | 2.44 | 3.82 | 19.12 | 20.99 | 30.88 |
| Gloss | 20° | | 10.50 | 3.70 | 1.10 | 2.70 | 0.50 | 5.00 |
| | 60° | | 41.30 | 21.50 | 9.20 | 19.70 | 5.30 | 32.40 |
| | 85° | | 58.90 | 36.60 | 18.50 | 43.40 | 21.20 | 61.50 |
| Clarity | 0.125 | mm | 3.00 | 2.40 | 2.30 | 2.90 | 2.50 | 3.80 |
| | 0.25 | mm | 1.60 | 1.20 | 0.90 | 1.10 | 1.60 | 2.50 |
| | 0.5 | mm | 1.70 | 1.00 | 1.60 | 1.40 | 2.00 | 2.80 |
| | 1 | mm | 3.60 | 2.90 | 3.00 | 3.00 | 3.90 | 3.70 |
| | 2 | mm | 27.40 | 12.60 | 6.60 | 11.10 | 6.80 | 13.50 |

| | | | | | | | |
|---|---|---|---|---|---|---|---|
| | Total | 37.30 | 20.10 | 14.40 | 19.5 | 16.80 | 36.30 |
| Surface | Sz [μm] | 9.37 | 11.02 | 17.12 | 12.79 | 12.16 | 9.04 |
| roughness | Sa [μm] | 0.33 | 0.37 | 0.42 | 0.37 | 0.58 | 0.30 |
| | SΔq [°] | 0.20 | 0.29 | 0.51 | 0.31 | 0.81 | 0.22 |
| | Sdr [%] | 1.87 | 3.73 | 9.84 | 4.20 | 24.14 | 2.16 |

| | | | | | | |
|---|---|---|---|---|---|---|
| Anti-glare evaluation | LV4 | LV5 | LV5 | LV5 | LV5 | LV5 |
| Impurity masking | ⊚ | ⊚ | ⊚ | ⊚ | ⊚ | ⊚ |
| evaluation | | | | | | |

From Table 1, the anti-glare film with a rPET substrate obtained in Examples 1 to 6, the amorphous silica microparticles in the anti-glare coating layer formed a concave-convex surface with a plurality of irregular protrusions to appear a desired anti-glare and impurity masking properties.

Although particular embodiments have been shown and described, it should be understood that the above discussion is not intended to limit the present invention to these embodiments. Persons skilled in the art will understand that various changes and modifications may be made without departing from the scope of the present invention as literally and equivalently covered by the following claims.

What is claimed is:

1. An anti-glare film comprises
a rPET substrate comprising at least 50% recycled PET resin; and
an anti-glare coating layer coated on the rPET substrate;
wherein the anti-glare coating layer comprises an acrylate binder resin and a plurality of amorphous inorganic microparticles, and the use amount of the amorphous inorganic microparticles is ranging from 0.5 weight parts to 20.0 weight parts per hundred weight parts of the acrylate binder resin.

2. The anti-glare film as claimed in claim 1, wherein the rPET substrate has a haze of 0.1% to 3% and a light transmittance of at least 88%.

3. The anti-glare film as claimed in claim 1, wherein the total haze of the anti-glare film is more than 15% and the surface haze thereof is more than 12%.

4. The anti-glare film as claimed in claim 1, wherein the average particle size of the amorphous inorganic microparticles is ranging from 2.0 μm to 10 μm, the BET specific surface area thereof is ranging from 60 m²/g to 300 m²/g and the particle size distribution is ranging from 0.2 μm to 25.0 μm measured by laser diffraction.

5. The anti-glare film as claimed in claim 1, wherein the amorphous inorganic microparticles form a concave-convex surface with a plurality of irregular protrusions on the anti-glare layer, the surface roughness of the concave-convex surface has an maximum height (Sz) ranging from 5.0 μm to 20.0 μm, an arithmetical mean height (Sa) ranging from 0.10 μm to 1.0 μm, a root mean square gradient (SΔq) ranging from 0.10° to 1.5° and a developed interfacial area ratio (Sdr) ranging from 1.0% to 45.0%.

6. The anti-glare film as claimed in claim 1, wherein the rPET substrate comprises at least 80% recycled PET resin.

7. The anti-glare film as claimed in claim 1, wherein the use amount of the amorphous inorganic microparticles is ranging from 1.0 weight parts to 18.0 weight parts per hundred weight parts of the acrylate binder resin.

8. The anti-glare film as claimed in claim 1, wherein the anti-glare coating layer further comprises a plurality of spherical organic microparticles, the use amount of the spherical organic microparticles is ranging from 1.0 weight parts to 15.0 weight parts per hundred weight parts of the acrylate binder resin.

9. The anti-glare film as claimed in claim 8, wherein the average particle size of the spherical organic microparticles is ranging from 1.0 μm to 5.0 μm.

10. The anti-glare film as claimed in claim 1, wherein the amorphous inorganic microparticles are amorphous silica microparticles.
